(19) United States
(12) Patent Application Publication
(10) Pub. No.: US 2026/0138585 A1
(43) Pub. Date: May 21, 2026

(54) DRIVING ASSISTANCE APPARATUS FOR VEHICLE

(71) Applicant: SUBARU CORPORATION, Tokyo (JP)

(72) Inventor: Harunobu HORIGUCHI, Tokyo (JP)

(21) Appl. No.: 19/373,827

(22) Filed: Oct. 30, 2025

(30) Foreign Application Priority Data
Nov. 21, 2024 (JP) 2024-203305

(51) Int. Cl. B60W 10/20; B60W 10/04; B60W 10/18

(52) U.S. Cl. CPC B60W 10/20; B60W 10/04; B60W 10/18; B60W 2520/10; B60W 2520/28; B60W 2710/18; B60W 2710/20; B60W 2720/24; B60W 2720/26

(57) ABSTRACT

A driving assistance apparatus for a vehicle includes a sliding-down determiner that determines whether sliding-down of the vehicle occurs on a climbing lane; a steering controller that controls steering of the vehicle; a braking-driving controller that controls braking-driving force of each driving wheel at a front side and a rear side of the vehicle; a driving mode switcher that switches a driving mode between a drive mode and a reverse mode; and a vehicle controller that performs control to suppress the sliding-down if the sliding-down of the vehicle occurs. If the sliding-down of the vehicle occurs, the vehicle controller causes the driving mode switcher to switch the driving mode to the reverse mode, causes the braking-driving controller to perform the control to suppress the sliding-down, and causes the steering controller to perform control to turn around a head of a vehicle body of the vehicle to a downward direction.

### CROSS-REFERENCE TO RELATED APPLICATIONS

The present application claims priority from Japanese Patent Application No. 2024-203305 filed on November 21, 2024, the entire contents of which are hereby incorporated by reference.

### BACKGROUND

The disclosure relates to a driving assistance apparatus applied to a vehicle.

In general, when a vehicle is to be stopped from a state in which the vehicle runs on a slope road having an extremely low μ road surface (a low friction coefficient road surface, such as a snow road or an ice road), a driver who drives the vehicle loosely depresses a brake pedal while paying attention so as not to cause locking of wheels to gradually reduce the vehicle speed for stopping the vehicle.

At this time, if the weight component (mg·sinθ) along the slope when the vehicle (mass m) stops on the slope road (road gradient θ) is greater than a static friction coefficient μ of the slope road, sliding-down (a phenomenon in which the vehicle slides downward) occurs in a state in which tires are locked.

If the sliding-down of the vehicle occurs, the driver is upset and it is difficult for the driver to recover the tire lock through pumping of the brake or a loose accelerator operation (increase in driving force) with room in his/her mind. As a result, the driver often continues to depress the brake pedal. In particular, since the vehicle faces backward in the sliding-down from the climbing state, it is difficult for the driver to visually recognize the moving-backward direction and the driver feels a sense of anxiety.

Against this, for example, Japanese Unexamined Patent Application Publication (JP-A) No. 2009-274520 discloses a technique concerning a vehicle stop keeping apparatus that assists a driving operation when a vehicle that stops on a slope is smoothly started without the sliding-down (backward movement). If the sliding-down is detected, the apparatus estimates that the driver performs a steering operation and the braking force on turning wheels is opened or reduced.

### SUMMARY

An aspect of the disclosure provides a driving assistance apparatus configured to be applied to a vehicle. The driving assistance apparatus includes a sliding-down determiner, a steering controller, a braking-driving controller, a driving mode switcher, and a vehicle controller. The sliding-down determiner is configured to determine whether sliding-down of the vehicle occurs on a climbing lane. The steering controller is configured to control steering of the vehicle. The braking-driving controller is configured to control braking-driving force of each driving wheel at a front side and a rear side of the vehicle. The driving mode switcher is configured to switch a driving mode between a drive mode and a reverse mode. The vehicle controller is configured to perform control to suppress the sliding-down if the sliding-down determiner determines that the sliding-down of the vehicle occurs. The vehicle controller is configured to, if the sliding-down determiner determines that the sliding-down of the vehicle occurs, cause the driving mode switcher to switch the driving mode to the reverse mode, cause the braking-driving controller to perform the control to suppress the sliding-down, and cause the steering controller to perform control to turn around a head of a vehicle body of the vehicle to a downward direction.

An aspect of the disclosure provides a driving assistance apparatus applied to a vehicle. The driving assistance apparatus includes circuitry. The circuitry is configured to determine whether sliding-down of the vehicle occurs on a climbing lane. The circuitry is configured to control steering of the vehicle. The circuitry is configured to control braking-driving force of each driving wheel at a front side and a rear side of the vehicle. The circuitry is configured to switch a driving mode between a drive mode and a reverse mode. The circuitry is configured to perform control to suppress the sliding-down if it is determined that the sliding-down of the vehicle occurs. The circuitry is configured to, if it is determined that the sliding-down of the vehicle occurs, the driving mode is switched to the reverse mode, perform the control to suppress the sliding-down and control to turn around a head of a vehicle body of the vehicle to a downward direction.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram schematically illustrating the entire configuration of a driving assistance apparatus;

FIG. 2 is a flowchart illustrating a sliding-down driving assistance control routine;

FIG. 3 is a flowchart illustrating a change-in-direction control subroutine;

FIG. 4 is a flowchart illustrating a braking torque setting subroutine;

FIG. 5 is a table indicating slip distribution of each wheel in leftward turning-around;

FIG. 6 is a diagram for describing backward sliding-down of a vehicle;

FIG. 7 is a diagram for describing forward sliding-down of the vehicle after change in direction; and

FIG. 8 is a diagram for describing the orientation of the vehicle in the change in direction in respective states.

### DETAILED DESCRIPTION

In the technique disclosed in JP-A No. 2009-274520, the braking force on steering wheels is opened or reduced to prevent locking of the steering wheels and cause the lateral force on the steering wheels, thus assisting the steering operation by the driver.

The sliding-down on a climbing lane is a state in which the vehicle moves backward. Accordingly, the driver is upset and it is difficult for the driver to perform a steering wheel operation with room in his/her mind.

In particular, so-called "loss of steering control" occurs on a low μ road surface. In the "loss of steering control", the reaction force from the road surface when the driver performs the steering wheel operation is low to make the steering wheel operation light. Accordingly, it is likely to be difficult for the driver to accurately determine the orientation of the steering wheels with respect to the vehicle body.

It is desirable to provide a driving assistance apparatus applied to a vehicle, which does not cause upset of a driver driving the vehicle and which is capable of ensuring the stability of the vehicle even if sliding-down of the vehicle that stops on a climbing lane occurs.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

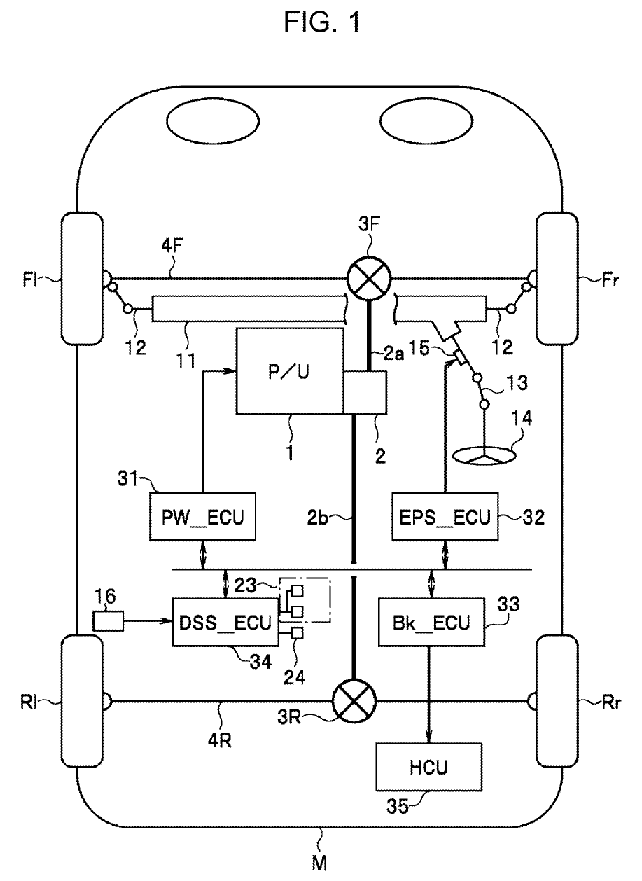

A vehicle M illustrated in FIG. 1 is a four-wheel drive vehicle. A power unit 1 is composed of a drive source and a transmission. An engine, an electric motor, or both of the engine and the electric motor are mounted in the power unit 1 as the drive source. A center differential mechanism (center differential) 2 is linked to an output shaft of the power unit 1. A front differential mechanism (front differential) 3F and a rear differential mechanism (rear differential) 3R are linked via output shaft 2a and 2b, respectively, in a front-back direction from the center differential 2.

Front axle shafts 4F extend left and right from the front differential 3F. The left and right front axle shafts 4F are linked to a left front-side driving wheel Fl and a right front-side driving wheel Fr, respectively. The front-side driving wheels Fl and Fr also serve as steering wheels. Rear axle shafts 4R extend left and right from the rear differential 3R. The left and right rear axle shafts 4R are linked to a left rear-side driving wheel Rl and a right rear-side driving wheel Rr, respectively. The respective driving wheels Fl, Fr, Rl, and Rr are hereinafter comprehensively referred to as driving wheels Aw.

A steering mechanism 11 is disposed in parallel with the front axle shafts 4F. Tie rods 12 extends left and right from the steering mechanism 11. The left and right tie rods 12 are linked to the front-side driving wheels Fl and Fr, respectively. A steering shaft 13 extends toward a driver seat side from a middle portion of the steering mechanism 11. A steering wheel 14 is fixedly provided at an end portion at the driver seat side of the steering shaft 13.

In response to an operation of the steering wheel 14 by a driver who drives the vehicle M, the tie rods 12 extending left and right from the steering mechanism 11 slide left and right via the steering shaft 13 to turn the front-side driving wheels Fl and Fr in response to the sliding of the tie rods 12. An electric power steering (EPS) motor 15 is linked to a portion close to the steering mechanism 11 on the steering shaft 13 via a transfer mechanism (not illustrated).

The drive source and the transmission provided in the power unit 1 are controlled based on an output control signal and a shift control signal, which are output from a power control unit (power control electronic control unit (PW_ECU)) 31. The PW_ECU 31 and a brake control unit (Bk_ECU) 33 described below compose a braking-driving controller according to an embodiment of the disclosure.

Assistance torque (EPS torque) added to the steering shaft 13 by the EPS motor 15 is controlled by an EPS control unit (EPS_ECU) 32, which serves as a steering controller according to an embodiment of the disclosure.

In addition, the Bk_ECU 33 is mounted in the vehicle M. A hydraulic control unit (HCU) 35 is connected to an output side of the Bk_ECU 33. The HCU 35 is a hydraulic circuit that adjusts brake hydraulic pressure in accordance with a driving signal from the Bk_ECU 33. The brake hydraulic pressure is supplied to a brake actuator provided in a brake mechanism (not illustrated) of each driving wheel Aw. Braking torque of each driving wheel Aw is adjusted with the brake hydraulic pressure.

The respective ECUs 31 to 33 described above are connected to a driving support system (DSS) control unit (DSS_ECU) 34 via, for example, an in-vehicle network using controller area network (CAN) communication or the like so as to be capable of bidirectional communication. The DSS_ECU 34 corresponds to a vehicle controller according to an embodiment of the disclosure.

Each of the ECUs 31 to 34 is composed of a microcontroller. The microcontroller includes a central processing unit (CPU), a random access memory (RAM), a read only memory (ROM), a rewritable non-volatile memory (a flash memory or an electrically erasable programmable read only memory (EEPROM)), and peripheral devices. The RAM in the microcontroller is provided as a working area of the CPU and a variety of data in the CPU is temporarily stored in the RAM. Programs, fixed data, and so on used to perform the respective processes in the CPU are stored in the ROM. The CPU is also called a microprocessor or a processor. A graphics processing unit (GPU) or a graph streaming processor (GSP) may be used, instead of the CPU. Alternatively, the CPU, the GPU, and the GSP may be selectively combined for use.

The operation of each of the ECUs 31 to 33 is basically controlled in accordance with a control signal from the DSS_ECU 34. A sensor switch group 16 is connected at an input side of the DSS_ECU 34. Sensor switches that acquire parameters used to control the operations performed in the respective ECUs 31 to 33 are collectively referred to as the sensor switch group 16. The sensor switch group 16 includes a brake switch, an accelerator position sensor, a wheel speed sensor, a forward and backward acceleration sensor, a vehicle body speed detector, a steering angle sensor, a yaw rate sensor, and so on.

The functions of the sensor switches provided in the sensor switch group 16 will now be simply described. The brake switch detects depression of a brake pedal by the driver and outputs an ON signal in response to depression of the brake pedal by the driver. The accelerator position sensor detects the degree of depression of an accelerator pedal by the driver. The wheel speed sensor detects a wheel speed Vw of each driving wheel Aw. The vehicle speed is calculated from an average of the respective wheel speeds Vw.

The forward and backward acceleration sensor detects forward and backward acceleration (G) in movement of the vehicle body and a gradient direction of a road surface, which indicates whether a climbing slope or a decline slope exists in the moving direction of the vehicle M, based on the acceleration. The vehicle body speed detector detects a moving speed of the vehicle body (a vehicle body speed Vv). For example, when positional information from a global navigation satellite system (GNSS) satellite is capable of being acquired, the vehicle body speed detector estimates the vehicle body speed Vv from the amount of movement per unit time based on the positional information from the GNSS satellite. Alternatively, the vehicle body speed detector estimates the vehicle body speed Vv based on change in the acceleration detected by the forward and backward acceleration sensor. Alternatively, the vehicle body speed detector may estimate the vehicle body speed Vv from the amount of movement per unit time of a target point based on information about an image of the target point, captured by a forward recognition camera unit 23 described below.

The steering angle sensor detects a steering angle caused by the operation of the steering wheel 14 by the driver. The yaw rate sensor detects a yaw rate exerted on the vehicle body.

Furthermore, the forward recognition camera unit 23 and a backward recognition unit 24 are connected at the input side of the DSS_ECU 34. The forward recognition camera unit 23 is a stereo camera and includes a main camera and a sub-camera. The forward recognition camera unit 23 acquires reference image data with the main camera and acquires comparison image data with the sub-camera. The forward recognition camera unit 23 recognizes the same object in both of the images based on the parallax between the reference image data and the comparison image data and calculates distance data (the distance from the vehicle M to the object) to acquire forward running environment information ahead of the vehicle M. The backward recognition unit 24 includes a monocular camera and a backward radar. The backward recognition unit 24 acquires backward running environment information behind the vehicle M based on a backward environment image captured with the monocular camera and scanning data from the backward radar.

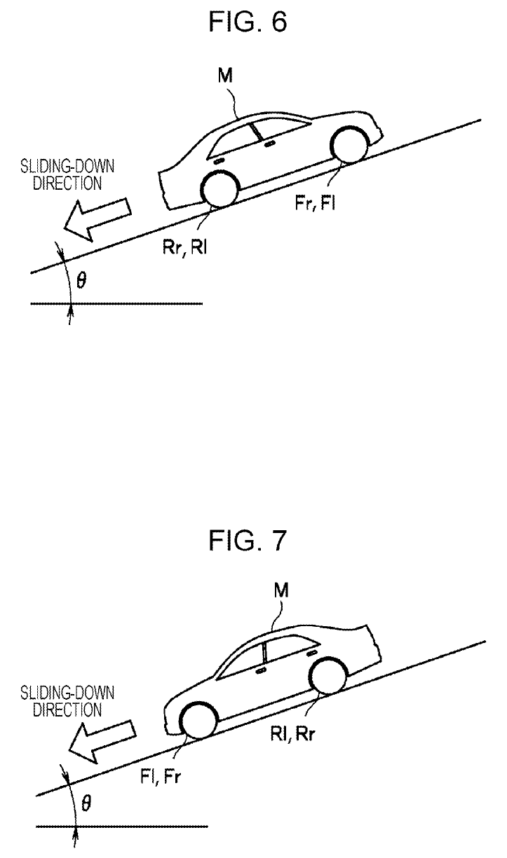

When the vehicle M is to be stopped on an extremely low μ road surface (a low friction coefficient road surface, such as a snow road or an ice road), the driver loosely depresses the brake pedal so as not to cause locking of tires to gradually reduce the vehicle speed of the vehicle M for stopping the vehicle. However, when the extremely low μ road surface is a climbing lane, if a weight component (mg·sinθ) along the slope of the vehicle M exceeds a static friction coefficient of the climbing lane due to road gradient θ, sliding-down occurs in a state in which the tires are locked. As illustrated in FIG. 6, the vehicle M slides backward on the climbing lane.

In general, when the vehicle M slides backward, the driver depresses the brake pedal to attempt to stop the sliding-down. Alternatively, the driver depresses the accelerator pedal to attempt to stop the sliding-down. If the driver depresses the brake pedal in a state in which gripping force of the tires is reduced, the tires are locked. If the driver depresses the accelerator pedal in the state in which the gripping force of the tires is reduced, tire slip occurs. In addition, so-called "loss of steering control" occurs on a low μ road surface and the vehicle M is likely not to be steered.

When the vehicle M slides backward as in the manner described above, the driver is upset and it is difficult for the driver to perform a brake operation (pumping of the brake), a loose accelerator operation, and a steering wheel operation with room in his/her mind.

If the sliding-down is detected when the driver stops the vehicle M on the climbing lane having the extremely low μ road surface, the DSS_ECU 34 performs driving assistance in which the head of the vehicle body of the vehicle M is turned to the sliding-down direction to improve the visuality in the sliding-down direction, thus suppressing the upset of the driver.

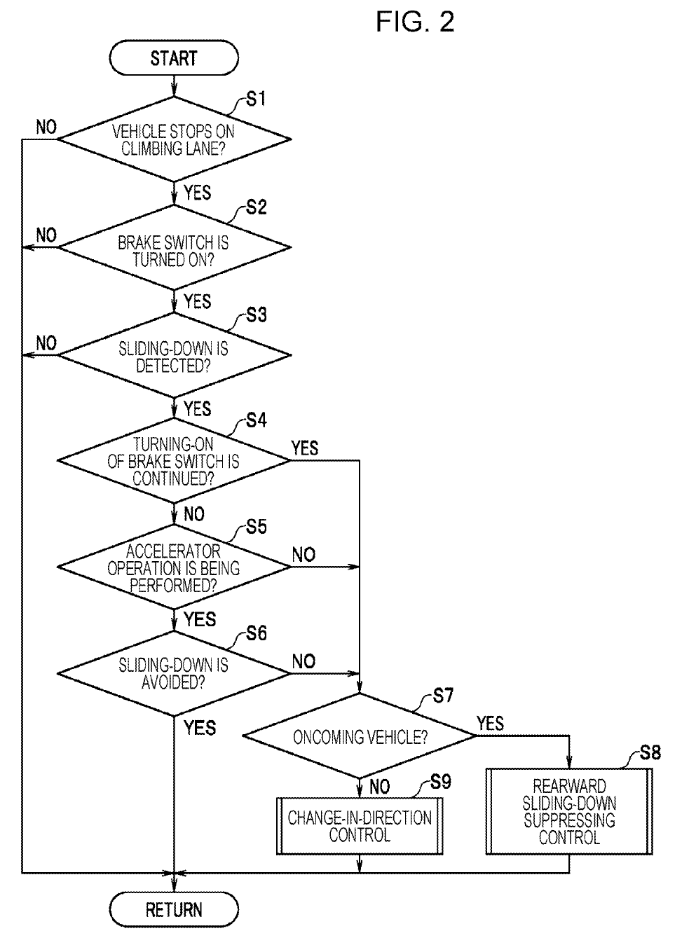

Driving assistance control in the DSS_ECU 34 is performed in accordance with, for example, a sliding-down driving assistance control routine illustrated in FIG. 2. A road having left-side traffic regulation is exemplified in the following description.

Referring to the subroutine in FIG. 2, in Step S1, the DSS_ECU 34 determines whether the vehicle M stops on the climbing lane. Whether the road is the climbing lane is determined based on the road gradient θ detected by the forward and backward acceleration sensor provided in the sensor switch group 16. In addition, whether the vehicle M stops is determined based on the vehicle speed calculated from the wheel speed Vw detected by the wheel speed sensor.

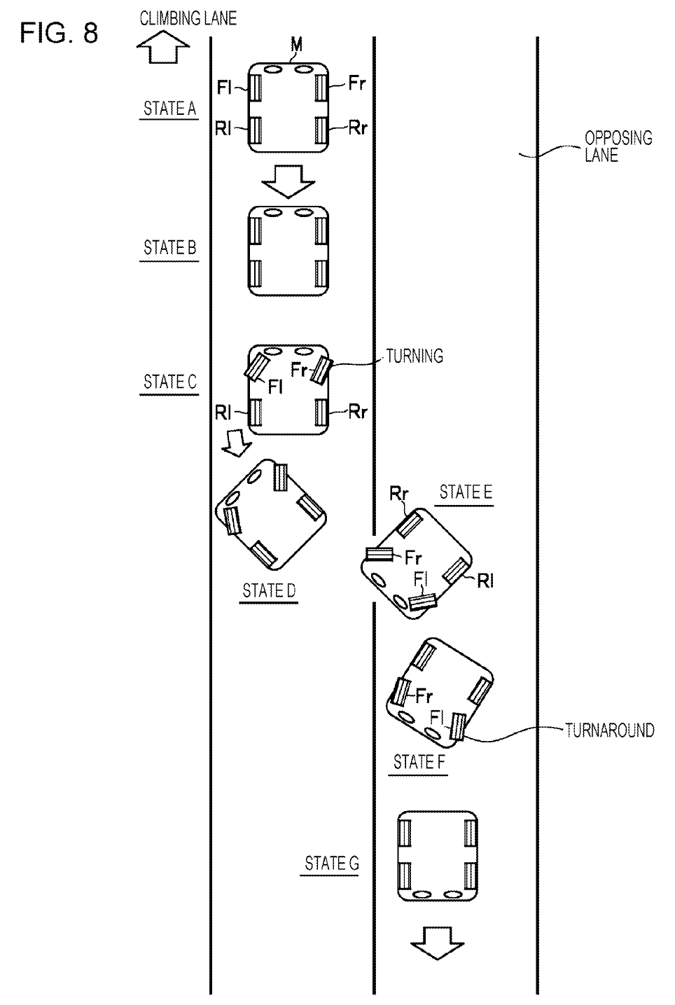

If the DSS_ECU 34 determines that the vehicle M does not stop on the climbing lane or the road on which the vehicle M stops is not the climbing lane (NO in Step S1), the DSS_ECU 34 escapes from the routine. If the DSS_ECU 34 determines that the vehicle M stops on the climbing lane (YES in Step S1: a state A in FIG. 8), in Step S2, the DSS_ECU 34 determines whether the brake switch provided in the sensor switch group 16 is turned on.

The brake switch outputs the ON signal when the driver depresses the brake pedal. If the DSS_ECU 34 determines that the brake switch is turned off and the driver does not depress the brake pedal (NO in Step S2), the DSS_ECU 34 escapes from the routine. If the driver does not depress the brake pedal even when the vehicle stops on the climbing lane, it is considered that the driver does not expect the driving assistance through control intervention.

If the brake switch is turned on (YES in Step S2), the DSS_ECU 34 determines that the driver attempts to keep the stopped state of the vehicle M. In Step S3, the DSS_ECU 34 determines whether backward sliding-down occurs. Step S3 corresponds to a sliding-down determiner according to an embodiment of the disclosure.

The sliding-down here supposes a state in which the tires are locked due to the brake operation by the driver and in which the vehicle M moves backward. Accordingly, a state in which the degree of depression of the brake pedal by the driver is low and the vehicle M moves backward due to shortage of the braking torque is excluded here.

Whether the sliding-down of the vehicle M occurs is determined based on the vehicle body speed Vv [Km/h] detected by the vehicle body speed detector provided in the sensor switch group 16 and the wheel speed Vw [Km/h] detected by the wheel speed sensor provided in the sensor switch group 16. If the vehicle body speed Vv is detected by the vehicle body speed detector (0>Vv) but the wheel speed Vw is not detected by the wheel speed sensor (a locked state) (Vw=0), the DSS_ECU 34 determines that the sliding-down occurs (YES in Step S3). If both the vehicle body speed Vv and the wheel speed Vw are detected (Vv>0 and Vw>0) or if the vehicle body speed Vv is 0 [Km/h], the DSS_ECU 34 determines that the sliding-down is not detected (NO in Step S3) and escapes from the routine.

If the sliding-down is detected (YES in Step S3), in Steps S4 to S6, the DSS_ECU 34 determines whether the driver expects the driving assistance through the control intervention.

In Step S4, the DSS_ECU 34 determines whether the turning-on of the brake switch is continued. If the turning-on of the brake switch is continued (YES in Step S4), the DSS_ECU 34 determines that the driving assistance is expected because the tires are locked and goes to Step S7. If the brake switch is turned off (NO in Step S4), the tires are rotating and the DSS_ECU 34 determines that the driver is performing an operation to escape from the sliding-down.

If the brake switch is turned off (NO in Step S4), in Step S5, the DSS_ECU 34 determines whether the driver is performing the accelerator operation. Whether the driver is performing the accelerator operation is determined based on an output signal from the accelerator position sensor provided in the sensor switch group 16. A driving mode at this time is a drive mode (moving forward). Accordingly, the driver performs the accelerator operation to attempt to move to the climbing slope direction.

If the driver is not performing the accelerator operation (NO in Step S5), the DSS_ECU 34 determines that the driver does not performing the operation to avoid the sliding-down and goes to Step S7. If the driver is performing the accelerator operation (YES in Step S5), the DSS_ECU 34 estimates that the driver is performing the operation to avoid sliding-down. In Step S6, the DSS_ECU 34 determines whether the sliding-down is avoided. Whether the sliding-down is avoided is determined based on, for example, the forward running environment information captured by the forward recognition camera unit 23. Alternatively, whether the sliding-down is avoided is determined based on the vehicle body speed Vv and the wheel speed Vw.

When the DSS_ECU 34 determines whether the sliding-down is avoided based on the running environment information, the DSS_ECU 34 checks change in the distance per unit time between an image of a certain target point (a fixed stereoscopic point) and the vehicle M. If the distance between the target point and the vehicle M is not changed or is decreased, the DSS_ECU 34 determines that the sliding- down is avoided. If the distance between the target point and the vehicle M is increased, the DSS_ECU 34 determines that the sliding-down is not avoided.

When the DSS_ECU 34 determines whether the sliding-down is avoided based on the vehicle body speed Vv and the wheel speed Vw, the DSS_ECU 34 checks the moving direction at the vehicle body speed Vv and the rotation direction at the wheel speed Vw. If the moving direction at the vehicle body speed Vv is opposite to the rotation direction at the wheel speed Vw, the DSS_ECU 34 determines that the sliding-down is not avoided. If the moving direction at the vehicle body speed Vv is the same as the rotation direction at the wheel speed Vw or if the vehicle body speed Vv is 0 [Km/h], the DSS_ECU 34 determines that the sliding-down is avoided.

If the DSS_ECU 34 determines that the sliding-down is avoided (YES in Step S6), the DSS_ECU 34 escapes from the routine. If the DSS_ECU 34 determines that the sliding-down is not avoided (NO in Step S6), the DSS_ECU 34 goes to Step S7.

In Step S7 after any of Steps S4 to S6, the DSS_ECU 34 determines whether a vehicle (an oncoming vehicle) coming close to the vehicle M from an opposing lane exists. The presence of the oncoming vehicle coming close to the vehicle M is determined based on the forward running environment information captured by the forward recognition camera unit 23.

If the DSS_ECU 34 determines that an oncoming vehicle coming close to the vehicle M exists (YES in Step S7), in Step S8, the DSS_ECU 34 performs backward sliding-down suppressing control and, then, escapes from the routine. If the DSS_ECU 34 determines that an oncoming vehicle coming close to the vehicle M does not exist (NO in Step S7), in Step S9, the DSS_ECU 34 performs change-in-direction control and, then, escapes from the routine. Since, for example, the same process as in a "backward sliding-down suppressing control subroutine" described in JP-A No. 2023-13808 is performed in the backward sliding-down suppressing control performed by the DSS_ECU 34 in Step S8, description of the backward sliding-down suppressing control performed by the DSS_ECU 34 in Step S8 is omitted herein.

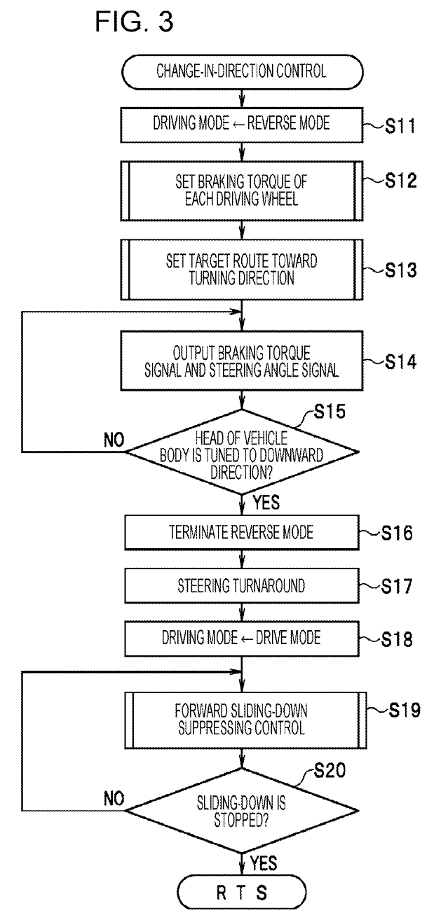

The change-in-direction control in Step S9 is performed in accordance with a change-in-direction control subroutine illustrated in FIG. 3. The DSS_ECU 34 performs forced intervention of control of each of the ECUs 31 to 33 in this subroutine. Accordingly, the operations of the brake pedal, the accelerator pedal, and the steering wheel 14 by the driver are temporarily disabled. Consequently, in the change-in-direction control, the DSS_ECU 34 indicates start of the "change-in-direction control" to the driver using a monitor image and sound.

Referring to the subroutine in FIG. 3, in Step S11, the DSS_ECU 34 switches the driving mode to a reverse mode. The driving mode is switched in response to transmission of a reverse mode instruction signal to the PW_ECU 31 by the DSS_ECU 34. The PW_ECU 31 sets the transmission of the power unit 1 to reverse upon reception of the reverse mode instruction signal from the DSS_ECU 34 (a state B in FIG. 8). Step S11 and Step S18 described below correspond to a driving mode switcher according to an embodiment of the disclosure.

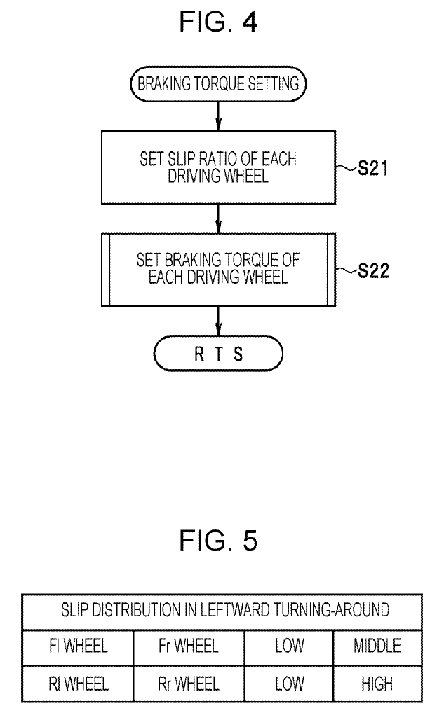

In Step S12, the DSS_ECU 34 sets the braking torque of each driving wheel Aw. The braking torque is set in accordance with a braking torque setting subroutine illustrated in FIG. 4.

Referring to the subroutine in FIG. 4, in Step S21, the DSS_ECU 34 sets a slip ratio λ of each driving wheel Aw in leftward turning-around. FIG. 5 is a table schematically indicating slip distribution of each driving wheel Aw in the leftward turning-around.

When the head of the vehicle M is to be turned around in the leftward direction in the backward sliding-down, the slip ratio λ of the left front-side driving wheel Fl and the left rear-side driving wheel Rl, which are curved outward, is set to "Low". The slip ratio λ of the right front-side driving wheel Fr is set to "Middle". The slip ratio λ of the right rear-side driving wheel Rr is set to "High". In the present embodiment, λ≈100 [%] at "High" (substantially in a tire locked state), λ=70[%] to 50 [%] at "Middle" (a state in which the gripping force is slightly recovered), and λ=30 [%] or less at "Low" (a state in which the gripping force is recovered).

The slip ratio λ of the outer wheels Fl and Rl in the turning-around is set to "Low" to recover the gripping force. In contrast, the slip ratio λ of the right rear-side driving wheel Rr at the inner wheel side is set to "High" to cause the rear-side driving wheel Rr to follow the outer wheels Fl and Rl in the turning-around. Although the following capability is improved if the slip ratio λ of the right front-side driving wheel Fr at the inner wheel side is also set to "High" at this time, the right front-side driving wheel Fr is the steering wheel. Accordingly, the slip ratio λ of the right front-side driving wheel Fr is set to "Middle" to be in a state in which the gripping force is recovered to some extent, thus attempting to improve the steering performance.

Then, the driving wheels Fl and Rl at the outer side in the turning-around, the slip ratio λ of which is set to "Low", are slowly driven. At this time, the head of the vehicle M is slowly turned around in the leftward direction through the turning of the driving wheel Fl at the outer side in the turning-around and the driving wheel Fr at the inner side in the turning-around. The right rear-side driving wheel Rr is caused to follow this operation.

In Step S22, the DSS_ECU 34 sets the braking torque corresponding to the slip ratio λ of each driving wheel Aw. Then, the DSS_ECU 34 goes to Step S13 in FIG. 3.

To perform the change-in-direction control, the DSS_ECU 34 supplies a signal to suppress driving force to be applied to each driving wheel Aw to the PW_ECU 31. The PW_ECU 31 suppresses the output from the drive source of the power unit 1 and sets the transmission gear ratio of the transmission to about a second gear of the step transmission. As a result, the driving force to be applied to each driving wheel Aw is set to a value lower than the value of creep force.

The DSS_ECU 34 sets the braking torque for setting the driving force output from each driving wheel Aw to the value corresponding to the slip ratio λ. Setting the braking torque to a low value makes the slip ratio λ of the tires low and setting the braking torque to a high value makes the slip ratio λ of the tires high.

In Step S13 in FIG. 3, the DSS_ECU 34 sets a target route for causing the vehicle M to move in the turning direction.

For example, the DSS_ECU 34 recognizes the road width, the shape of the road surface, and so on based on the running environment information in the downward direction, acquired with the backward recognition unit 24. Then, the DSS_ECU 34 sets the target route that desirably leads the vehicle M to the turning direction at the recognized road width and in the recognized shape of the road surface.

First, the DSS_ECU 34 sets a target destination in the downward direction of the opposing lane based on the running environment information acquired with the backward recognition unit 24. Then, the DSS_ECU 34 sets the target route that causes the direction of the vehicle M to be changed to lead the vehicle M to the target destination.

In Step S14, the DSS_ECU 34 outputs a braking torque signal to each driving wheel Aw and a steering angle signal that traces the target route. The DSS_ECU 34 supplies the braking torque signal to each driving wheel Aw to the Bk_ECU 33. The DSS_ECU 34 supplies the steering angle signal to the EPS_ECU 32.

The Bk_ECU 33 supplies the driving signal corresponding to the braking torque signal from the DSS_ECU 34 to the HCU 35. The HCU 35 makes the brake actuator provided in the brake mechanism of each driving wheel Aw work in accordance with the driving signal from the Bk_ECU 33 to adjust the braking torque.

The EPS_ECU 32 supplies the driving signal corresponding to the steering angle signal from the DSS_ECU 34 to the EPS motor 15. The EPS motor 15 makes the steering mechanism 11 work to turn the front-side driving wheels Fl and Fr (a state C in FIG. 8).

In Step S15, the DSS_ECU 34 determines whether the head of the vehicle body of the vehicle M is turned to the downward direction. Whether the head of the vehicle body of the vehicle M is turned to the downward direction is determined based on the running environment information acquired by any of the forward recognition camera unit 23 and the backward recognition unit 24 or change in the road gradient direction detected by the forward and backward acceleration sensor.

If the DSS_ECU 34 determines that the change-in-direction is not completed (NO in Step S15), the DSS_ECU 34 goes back to Step S14 and repeats Steps S14 to S15 until the head of the vehicle body of the vehicle M is turned to the downward direction (states D to E in FIG. 8). In the present embodiment, when the head of the vehicle body of the vehicle M is capable of moving to the road downward direction, the DSS_ECU 34 determines that the change-in-direction is completed.

If the DSS_ECU 34 determines that the change-in-direction of the vehicle M is completed (YES in Step S15: the state E in FIG. 8), in Step S16, the DSS_ECU 34 terminates the reverse mode.

In Step S17, the DSS_ECU 34 supplies a turnaround signal that directs the head of the vehicle body of the vehicle M to the downward slope direction to the EPS_ECU 32. The steering angle in the turnaround of the steering may be set to a predetermined value. The EPS_ECU 32 drives the EPS motor 15 in response to the turnaround signal from the DSS_ECU 34 and makes the steering mechanism 11 work to turn the front-side driving wheels Fl and Fr (a state F in FIG. 8). This prevents the vehicle M to be directed sideways with respect to the downward direction. At this time, the DSS_ECU 34 sets the slip ratio λ of each driving wheel Aw to "Low".

In Step S18, the DSS_ECU 34 switches the driving mode to the drive mode. The switching of the driving mode is performed in response to transmission of a driving mode switching signal to the PW_ECU 31 by the DSS_ECU 34. The PW_ECU 31 switches the transmission of the power unit 1 from reverse to drive in response to the driving mode switching signal from the DSS_ECU 34.

In Step S19, the DSS_ECU 34 performs forward sliding-down suppressing control. The orientation of the vehicle M is directed to the downward direction of the road through the sliding-down suppressing control (FIG. 7 and a state G in FIG. 8). Since, for example, the same process as in a "forward sliding-down suppressing control subroutine" described in JP-A No. 2023-13808 is performed in the forward sliding-down suppressing control performed by the DSS_ECU 34 in Step S19, description of the forward sliding-down suppressing control performed by the DSS_ECU 34 in Step S19 is omitted herein.

In Step S20, the DSS_ECU 34 determines whether the sliding-down of the vehicle M is stopped. Whether the sliding-down of the vehicle M is stopped is determined based on, for example, the forward running environment information acquired by the forward recognition camera unit 23. Alternatively, whether the sliding-down of the vehicle M is stopped is determined based on the vehicle body speed Vv.

If the DSS_ECU 34 determines that the sliding-down is continued (NO in Step S20), the DSS_ECU 34 repeats Steps S19 to S20. If the DSS_ECU 34 determines that the sliding-down is stopped (YES in Step S20), the DSS_ECU 34 escapes from the routine.

As described above, in the present embodiment, when the DSS_ECU 34 detects the sliding-down of the vehicle M that stops on the climbing lane, the control to change the direction of the vehicle M is performed. The head of the vehicle body of the vehicle M is slowly turned around through the change-in-direction control by the DSS_ECU 34 (the states D to E in FIG. 8) and is directed to the downward direction (the state G in FIG. 8).

Accordingly, even if the backward sliding-down occurs when the driver stops the vehicle M on the climbing lane, the direction of the vehicle M is automatically changed to the moving-forward direction in which the control is relatively easy, compared with the backward movement. Accordingly, since the driver is visually relieved and is not upset, the driver is capable of getting rid of a sense of anxiety. In addition, since the control by the driver is capable of being easily performed, it is possible to ensure the stability of the vehicle M.

The disclosure is not limited to the above embodiment. For example, Steps S19 and S20 in the change-in-direction control subroutine described above may be omitted and the driver may perform the driving operation of the vehicle M after the DSS_ECU 34 completes the change-in-direction of the vehicle M.

According to the disclosure, when it is determined that the sliding-down of the vehicle occurs on the climbing lane, the driving mode is switched to the reverse mode, the control to suppress the sliding-down is performed, and the control to turn around the head of the vehicle body of the vehicle to the downward direction is performed to change the direction of the vehicle. Accordingly, the driver is capable of easily control the vehicle, compared with a case in which the vehicle slides down in the backward direction. As a result, the upset of the driver is suppressed and it is possible to ensure the stability of the vehicle.

The PW_ECU 31, the EPS_ECU 32, the Bk_ECU 33, and the DSS_ECU 34 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the PW_ECU 31, the EPS_ECU 32, the Bk_ECU 33, and the DSS_ECU 34. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A driving assistance apparatus configured to be applied to a vehicle, the driving assistance apparatus comprising:
a sliding-down determiner configured to determine whether sliding-down of the vehicle occurs on a climbing lane;
a steering controller configured to control steering of the vehicle;
a braking-driving controller configured to control braking-driving force of each driving wheel at a front side and a rear side of the vehicle;
a driving mode switcher configured to switch a driving mode between a drive mode and a reverse mode; and
a vehicle controller configured to perform control to suppress the sliding-down if the sliding-down determiner determines that the sliding-down of the vehicle occurs,
wherein the vehicle controller is configured to, if the sliding-down determiner determines that the sliding-down of the vehicle occurs, cause the driving mode switcher to switch the driving mode to the reverse mode, cause the braking-driving controller to perform the control to suppress the sliding-down, and cause the steering controller to perform control to turn around a head of a vehicle body of the vehicle to a downward direction.

2. The driving assistance apparatus according to claim 1,
wherein the vehicle controller is configured to cause the braking-driving controller to set a slip ratio of the driving wheels at an outer side in the turning-around to a low value in the turning-around of the head of the vehicle body of the vehicle to the downward direction.

3. The driving assistance apparatus according to claim 2,
wherein the vehicle controller is configured to cause the braking-driving controller to set the slip ratio of the driving wheels at an inner side in the turning-around to a value higher than the value of the slip ratio of the driving wheels at the outer side in the turning-around in the turning-around of the head of the vehicle body of the vehicle to the downward direction.

4. The driving assistance apparatus according to claim 3,
wherein steering wheels of the vehicle are front wheels, and
wherein the vehicle controller is configured to cause the braking-driving controller to set the slip ratio of a rear wheel at the inner side in the turning-around to a value higher than the value of the slip ratio of the front wheel at the inner side in the turning-around in the turning-around of the head of the vehicle body of the vehicle to the downward direction.

5. The driving assistance apparatus according to claim 1,
wherein the sliding-down determiner is configured to determine that the sliding-down occurs if a wheel speed of each driving wheel is not detected but a vehicle body speed of the vehicle is detected.

6. A driving assistance apparatus configured to be applied to a vehicle, the driving assistance apparatus comprising:
circuitry configured to
determine whether sliding-down of the vehicle occurs on a climbing lane;
control steering of the vehicle;
control braking-driving force of each driving wheel at a front side and a rear side of the vehicle;
switch a driving mode between a drive mode and a reverse mode; and
perform control to suppress the sliding-down if it is determined that the sliding-down of the vehicle occurs,
wherein the circuitry is configured to, if it is determined that the sliding-down of the vehicle occurs, the driving mode is switched to the reverse mode, perform the control to suppress the sliding-down and control to turn around a head of a vehicle body of the vehicle to a downward direction.
